(19) United States
(12) Patent Application Publication
(10) Pub. No.: US 2026/0153964 A1
(43) Pub. Date: Jun. 4, 2026

(54) VEHICLE TOUCH BUTTON AND METHOD FOR PREVENTING MIS-OPERATION THEREOF

(71) Applicants: Hyundai Motor Company, Seoul (KR); Kia Corporation, Seoul (KR)

(72) Inventors: Hongling Zhou, Shandong (CN); Ping Ping Ma, Shandong (CN)

(21) Appl. No.: 19/272,533

(22) Filed: Jul. 17, 2025

(30) Foreign Application Priority Data
Oct. 11, 2024 (CN) 202411418751.5

(51) Int. Cl. G06F 3/041; B60K 35/10; B60K 35/81; G06F 3/04886

(52) U.S. Cl. CPC G06F 3/04186; B60K 35/10; B60K 35/81; G06F 3/04886; B60K 2360/115; B60K 2360/1438

(57) ABSTRACT

A vehicle touch button may include the touch film may include button detection regions spaced apart from each other and non-button detection regions located around the button detection regions, respectively, and the touch button may be configured to, when the button detection region is triggered and the non-button detection region is not triggered within a first reference time, generate a touch control signal corresponding to the button detection region if the same button detection region is still triggered after a second reference time has elapsed.

### CROSS-REFERENCE TO RELATED APPLICATIONS

This application claims priority to and the benefit of Chinese Patent Application No. 202411418751.5 filed with the Chinese National Intellectual Property Administration on Oct. 11, 2024, the entire contents of which is incorporated herein by reference.

### TECHNICAL FIELD

The present disclosure relates to a technical field of touch control. More particularly, the present disclosure relates to a vehicle touch button and a method for preventing mis-operation of a touch button.

### BACKGROUND

Touch buttons are a familiar human-computer interaction tool and are widely used in various (e.g. automotive) fields.

For example, although a user may input an operation for a vehicle by touching a display screen, there are often touch buttons below the display screen, such as a button to return the display screen to the homepage, a button to pop up a map on the display screen, and a button to open a media player on the display screen. Simple and direct interaction between the user and the vehicle is possible through these touch buttons.

However, when a user touches the display screen with one finger (e.g., an index finger), the user's other bent fingers may be placed on a touch button at the bottom of the display screen and may potentially touch the touch button, and, as the user's index finger moves on the display screen, the other bent finger may also move on this touch button. All of these can lead to the user's mis-operation of the touch buttons, which can affect the user experience. A similar situation may occur if the user's hand touches a touch button around the gear shift (e.g., an automatic parking button) while operating the gear shift.

Therefore, a vehicle touch button and a method for preventing mis-operation of a touch button, capable of preventing mis-operation, are urgently required.

The description of the above background technology is only for the convenience of in-depth understanding of the technical solutions of the present disclosure (in terms of the technical solutions used, the technical problems solved, and the technical effects generated), and should not be considered as acknowledging or implying in any way that the above information constitutes prior art known to those skilled in the art.

### SUMMARY

The present disclosure attempts to provide a vehicle touch button and a method for preventing mis-operation of a touch button capable of improving the performance of preventing mis-operation of the vehicle touch button.

A vehicle touch button may include the touch film may include button detection regions spaced apart from each other and non-button detection regions located around the button detection regions, respectively, and the touch button may be configured to, when the button detection region is triggered and the non-button detection region is not triggered within a first reference time, generate a touch control signal corresponding to the button detection region if the same button detection region is still triggered after a second reference time has elapsed.

The touch button may include a touch surface on an inner side of which the touch film is installed, the touch surface forms a button touch region corresponding to the button detection region of the touch film, form non-button touch region corresponding to and the non-button detection region of the touch film, and the button touch region and the non-button touch region are configured so that the button detection region is triggered, when the button touch region is touched, and the non-button detection region is triggered, when the non-button touch region is touched.

The touch film may be configured to generate a button touch signal when the button detection region is triggered, and generate a non-button touch signal when the non-button detection region is triggered, and the touch button may further include a circuit board electrically connected to the touch film, and may be configured to receive the button touch signal or the non-button touch signal, and when the button touch signal is received and the non-button touch signal is not received within the first reference time, generate the touch control signal according to the received button touch signal if the same the button touch signal is still received after the second reference time.

The circuit board may be configured to determine whether a non-button touch signal has been received, generate no touch control signal, when it is determined that the non-button touch signal has been received, determine whether the button touch signal has been received, when it is determined that the non-button touch signal has not been received, determine whether the first reference time has elapsed, when it is determined that the button touch signal has been received, determine whether a non-button touch signal has been received within the first reference time, when it is determined that the first reference time has elapsed, generate no touch control signal, when it is determined that the non-button touch signal has been received within the first reference time, determine whether the second reference time has elapsed, when it is determined that the non-button touch signal is not received within the first reference time, determine whether the same the button touch signal is still received, when it is determined that the second reference time has elapsed, generate no touch control signal, when it is determined that the same the button touch signal is no longer received, and generate the touch control signal according to the received button touch signal when it is determined that the same the button touch signal is still received.

The non-button detection region may include an interval between adjacent two button detection regions.

The touch button may further include a front cover and a rear cover configured to form a receiving space, the front cover may be used as the touch surface, and the touch film and the circuit board are installed in the receiving space.

In the front cover, an icon is formed in the button touch region.

A method for preventing mis-operation of a touch button is provided, where the touch button including a touch film, and the touch film may include button detection regions spaced apart from each other and non-button detection regions located around the button detection regions, respectively, where the method may include determining whether the button detection region is trigger and the non-button detection region is not triggered within a first reference time, determining whether the same button detection region is still triggered after a second reference time has elapsed, when it is determined that the button detection region is triggered and the non-button detection region has not been triggered within the first reference time, and generating, by the touch button, a touch control signal corresponding to the button detection region, when it is determined that the same button detection region is still triggered after the second reference time.

The determining whether the button detection region is trigger and the non-button detection region is not triggered within the first reference time may include determining whether the non-button detection region is triggered, determining whether the button detection region is triggered, when it is determined that the non-button detection region has not been triggered, determining whether the first reference time has elapsed, when it is determined that the button detection region has been triggered, determining whether the non-button detection region is triggered within the first reference time, when it is determined that the first reference time has elapsed, and determining that the button detection region is triggered and the non-button detection region is not triggered within the first reference time, when it is determined that the non-button detection region is not triggered within the first reference time.

The determining whether the same button detection region is still triggered after the second reference time has elapsed may include determining whether the second reference time has elapsed, determining whether the same button detection region is still triggered, when it is determined that the second reference time has elapsed, and determining that the same button detection region is still triggered after the second reference time, when it is determined that the same button detection region is still triggered.

The present disclosure adopts the above-described technical solution and has the following beneficial effects: the present disclosure improves a touch film in the hardware aspect, where a peripheral region in the improved touch film other than respective button detection regions is also set as a detection region (referred to as a non-button detection region), such that, when a user's finger touches a region other than the button touch region, the non-button detection region is triggered unlike the conventional art where the detection region is not triggered, and the improvement in this hardware aspect provides a basis for preventing mis-operation of the touch button.

In addition, the present disclosure improves a control logic in the software aspect, where the improved control logic may determine whether only a button detection region is triggered based on a first reference time, and when it is determined that only the button detection region has been triggered within the first reference time, proceed a delayed detection with respect to a triggered or non-triggered state of a previously triggered button detection region based on a second reference time, and generate a touch control signal when the button detection region is still triggered. Therefore, the performance of preventing mis-operation of the vehicle touch button may be effectively improved.

### BRIEF DESCRIPTION OF THE DRAWINGS

FIG. 1 is a schematic diagram of an example of a touch surface of touch button located below a display screen of a vehicle.

FIG. 2 is a schematic diagram of a button detection region of corresponding to the button touch region of FIG. 1 formed of a touch film according to the conventional art.

FIG. 3 is a schematic structural diagram of a vehicle touch button according to the technical solution of the present disclosure.

FIG. 4 is a schematic diagram of a detection region formed of a touch film according to the technical solution of the present disclosure.

FIG. 5 is an operation flowchart of a circuit board according to the technical solution of the present disclosure.

FIG. 6 is a detailed flowchart of a method for preventing mis-operation of a touch button according to the technical solution of the present disclosure.

### DETAILED DESCRIPTION OF ILLUSTRATIVE EMBODIMENTS

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

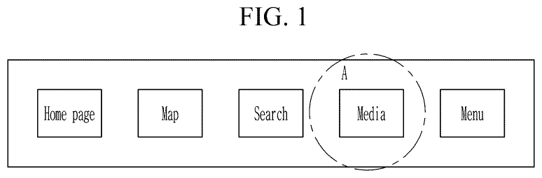

FIG. 1 is a schematic diagram of an example of a touch surface of a touch button located below a display screen of a vehicle. As shown in FIG. 1, the touch surface of the touch button has “Homepage”, “Map”, “Search”, “Media”, and “Menu” icons installed. During the process of manipulating the display screen, a user can identify a location of a button touch region according to “Home page”, “Map”, “Search”, “Media”, and “Menu” icons of the touch surface. That is, five button touch regions are formed on one touch surface of the touch button, a region where each icon is located may be used as the button touch region, and for example, boxes where icons of FIG. 1 are located are the button touch regions, respectively.

In order for the touch button to detect the touch operation of the user, a touch film is typically installed on an inner side of the touch surface, and a button detection region corresponding one-to-one to the button touch region of the touch surface may be formed in the touch film.

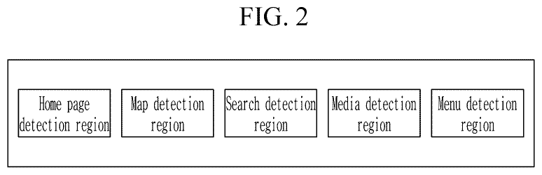

FIG. 2 is a schematic diagram of a button detection region corresponding to the button touch region of FIG. 1 formed of the aforementioned touch film. As shown in FIG. 2, the button detection region of the touch film may include “homepage detection region”, “map detection region”, “search detection region”, “media detection region” and “menu detection region”.

The controller may receive electric signal parameters of the respective button detection region in real time and determine whether to execute a corresponding operation. When FIG. 1 and FIG. 2 are combined, for example when the user touches the “homepage” icon in the case that the user needs to switch the display screen to the homepage, the electric signal of the homepage detection region corresponding thereto changes, and the controller detects the occurrence of the electric signal change of the homepage detection region, thereby determining that the homepage detection region has been triggered, and may execute the operation to return the display screen the homepage. In addition, when the user touches the button touch region, a detection region is not installed for a region other than the button touch region in the touch film of the conventional art, and there is no change in the electric signal of the detection region, so that the controller generates no operation.

In this case, when the user touches the display screen with an index finger, the user's other bent finger may be placed on the touch button so that the touch button below the display screen may be touched, and when the user's index finger moves from the display screen, the other bent fingers may move on the touch button. For example, within a short period, four fingers of the user may touch the “media” icon and at the same time touch a region above the “media” icon, and in addition, the four fingers move to the left to touch an interval between the “media” icon and the “search” icon. That is, within a short period, the user's fingers may continuously touch a region A of FIG. 1. At this time, as described above, the electric signal of the media detection region may change, and the controller can execute the operation to open the media player on the display screen. However, this may be merely a user's mis-operation of the touch button, and the operation to open the media player on the display screen is not what the user has intended.

In a similar situation, when the user places his or her hand on the center console and turns the gear shift, the user may not recognize that the hand is touching a touch button around the gear shift, and the user can possibly remove the hand from the touch button only after completing the manipulation of the gear shift device.

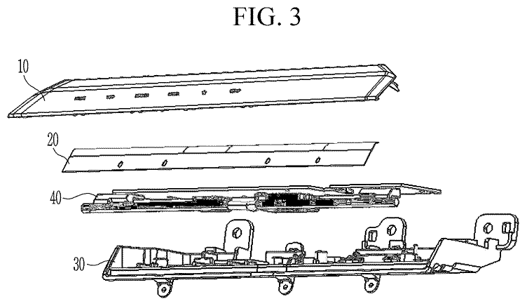

To solve this problem, the present invention provides a vehicle touch button. FIG. 3 is a schematic structural diagram of a vehicle touch button according to the technical solution of the present disclosure. As shown in FIG. 3, the touch button may include a touch film 20.

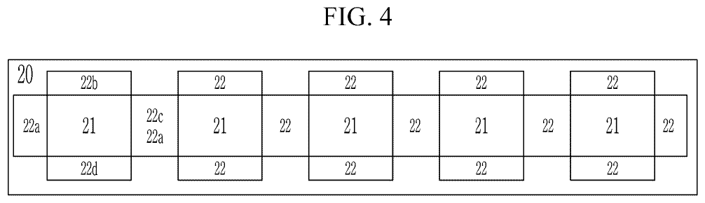

FIG. 4 is a schematic diagram of a detection region formed of the touch film according to the technical solution of the present disclosure. As shown in FIG. 4, the touch film 20 may include button detection regions 21 spaced apart from each other and non-button detection regions 22 located around the button detection regions 21, respectively.

Taking the touch button below the vehicle the display screen as an example, in the same way, five button detection regions 21 illustrated in FIG. 4 may be “homepage detection region”, “map detection region”, “search detection region”, “media detection region”, and “menu detection region”, respectively.

However, the present disclosure is not limited to installing the button detection region 21 in a rectangular shape, and the button detection region 21 may be any other shape. In addition, the present disclosure is not limited to arranging the button detection regions 21 in line, and the button detection region 21 may be arranged in two directions of up and down and left and right, or may be distributed and installed in any locations.

Unlike the conventional art, in the touch film 20, according to the technical solution of the present disclosure, a peripheral region other than the respective button detection regions 21 is also installed as a detection region, and may be referred to as the non-button detection region 22.

In simple cases, each non-button detection region 22 may include a sub-region 22a located on a left side of a corresponding button detection region 21, a sub-region 22b located above a corresponding button detection region 21, a sub-region 22c located on a right side of a corresponding button detection region 21 and a sub-region 22d located below a corresponding button detection region 21.

Therefore, the non-button detection region 22 may include the sub-region 22c on a right side of a first button detection region 21 and the sub-region 22a on a left side of a second button detection region 21 (installed spaced apart on a right side of the first button detection region 21). Since an interval between adjacent two button detection regions 21 is a region at which a user often mis-operates, as shown in FIG. 4, preferably, the sub-region 22c (e.g., of the left-most button detection region 21 of FIG. 4) and the sub-region 22a (e.g., of the second from the left button detection region 21 of FIG. 4) may be connected to be integrally formed. Thus, the non-button detection region 22 may include the interval between the adjacent two button detection regions 21.

However, in the present disclosure, the non-button detection region 22 is not limited thereto, and, for example, the non-button detection region 22 may form a cyclic region in which the head and tail of the sub-region are connected to each other, and, in addition, the shape of each sub-region is not limited to a rectangular shape.

Referring back to FIG. 3, according to the technical solution of the present disclosure, the touch button may include a front cover 10 and a rear cover 30 configured to form a receiving space. The front cover 10 may be used as the touch surface, and icons may be formed in the button touch region to receive the user's touch. The touch film 20 may be installed within the receiving space, and may be installed on an inner side of the touch surface (i.e., an interior surface of the front cover 10). The touch film 20 may be divided into several types such as resistive, radio-wave (e.g., surface acoustic wave), optical (infrared), inductive, electrostatic, and electromagnetic, depending on the operation principle. Taking the electrostatic touch film as an example, the electrostatic touch film may be easily in tight contact with the interior surface of a housing, for example, in tight contact with the interior surface of the front cover 10, and because there is no gap between the electrostatic touch film and the interior surface of the front cover 10, the electrostatic touch film can detect the touch when the user touches an exterior surface of the front cover 10.

In the technical solution of the present disclosure, what is the same as the conventional art is that the touch surface forms the button touch region corresponding to the button detection region 21 of the touch film 20. What is different from the conventional art is that the touch film 20 is provided with the non-button detection region 22, and accordingly, the touch surface forms non-button touch region(s) corresponding to the non-button detection region 22 of the touch film 20.

The operation principle in which the touch film detection region is triggered will be described with an example of the electrostatic touch film. Each detection region of the electrostatic touch film may include a detection electrode, and a distributed capacitance may exist between each pair of a detection electrode and the ground electrode. When the user's finger touches an appropriate region of the touch surface, a coupling capacitance may occur between the finger and the detection electrode. The capacitance value between the detection electrode and the ground electrode after the touch may be changed to a value obtained by the distributed capacitance and the coupling capacitance due to the parallel relationship of the coupling capacitance and the distributed capacitance. The electric signal of the detection region may be changed due to a change of the capacitance value between the detection electrode and the ground electrode after the touch, and, thereby, the detection region is triggered. Therefore, according to the operation principle, the button touch region and the non-button touch region are configured so that the button detection region 21 is triggered when the button touch region is touched, and the non-button detection region 22 is triggered when the non-button touch region is touched.

Therefore, when the user's finger touches a region other than the button touch region, according to the technical solution of the present disclosure, the non-button detection region 22 is triggered unlike the conventional art where the detection region is not triggered, and this provides a basis for preventing mis-operation of the touch button.

In more detail, according to the technical solution of the present disclosure, according to the touch button, when the button detection region 21 is triggered and the non-button detection region 22 is not triggered within a first reference time Δt, the touch button generates a touch control signal corresponding to the button detection region 21 if the same button detection region 21 is still triggered after a second reference time Td has elapsed.

That is, in order to generate the touch control signal by touching the button, the following two conditions need to be sequentially satisfied. A first condition is that the button detection region 21 is triggered and the non-button detection region 22 is not triggered within the first reference time Δt. For example, supposing a situation in which the user's finger continuously touches the region A of FIG. 1 within a short time (e.g., smaller than the first reference time Δt) as the first condition, the button detection region 21 and the non-button detection region 22 are all triggered within the first reference time Δt, and thereby the first condition is not satisfied. Therefore, since the touch button generates no touch control signal, the user's invoking of an unintended display screen operation due to the mis-operation of the touch button may be prevented.

When the first condition is satisfied, whether a second condition is satisfied is determined. The second condition is that the button detection region 21 is still triggered after the second reference time Td. That is, a triggered or a non-triggered state of the same button detection region 21 needs to be determined again after the second reference time Td (which may be called a touch delay time). If the same button detection region 21 is changed to the non-triggered state, which means that a short trigger of the button detection region 21 may be a mis-operation, the second condition is not satisfied, the touch button generates no touch control signal, and thereby the user's invoking of an unintended display screen operation due to the mis-operation of the touch button may be prevented.

According to an exemplary technical solution of the present disclosure, since a range of the value of the first reference time Δt may be 100 ms to 200 ms and a range of the value of the second reference time Td is 100 ms to 200 ms, the touch button has an excellent effect of preventing mis-operation. In addition, the first reference time Δt and the second reference time Td may be adjusted depending on specific situations.

In addition, the touch button further includes a long touch different from a short touch, for example, in the case of the long touch for 800 ms, a touch control signal different from the short touch is generated, and therefore, an upper limit of the value of the second reference time Td needs to be set to be smaller than the time required for the long touch so that the short touch and the long touch may be differentiated.

Hereinafter, the above-described two conditions will be described in more detail.

When the button detection region 21 is triggered, the touch film 20 may generate a button touch signal, and the button touch signal represents that the user has touched the button touch region. In addition, the button touch signal may represent specific touch button information. For example, when the homepage detection region is triggered, the button touch signal generated at the touch film 20 may represent that the touch button (i.e., “homepage” icon in FIG. 1) corresponding to returning the display screen to the homepage is touched.

When the non-button detection region 22 is triggered, the touch film 20 may generate a non-button touch signal. The non-button touch signal represents that the user has touched the non-button touch region, that is, a region around the button touch region. Preferably, the non-button touch signal may represent a particular touch position information, and, for example, the non-button touch signal generated at the touch film 20 may represent that an interval between the touch button (i.e., icon “homepage” of FIG. 1) for returning the display screen to the homepage and the touch button (i.e., icon “map” of FIG. 1) for popping up a map on the display screen has been touched.

Corresponding thereto, the vehicle touch button of the present disclosure may be installed in the receiving space formed of the front cover 10 and the rear cover 30, and may include a circuit board 40 electrically connected to the touch film 20. The circuit board 40 may be configured to receive the button touch signal and/or the non-button touch signal from the touch film 20.

According to the technical solution of the present disclosure, when the button touch signal is received and the non-button touch signal is not received within the first reference time Δt, the circuit board 40 generates the touch control signal according to the received button touch signal if the same the button touch signal is still received after the second reference time Td.

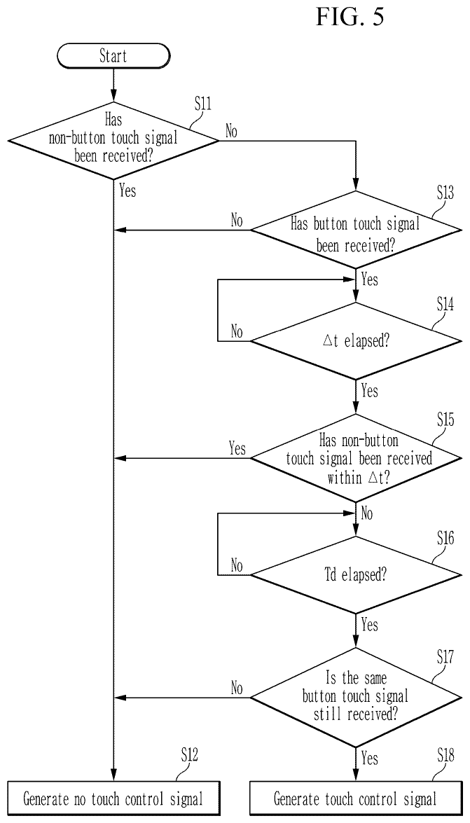

FIG. 5 is an operation flowchart of a circuit board according to the technical solution of the present disclosure. As shown in FIG. 5, at step S11, the circuit board 40 determines whether the non-button touch signal has been received. When it is determined that the non-button touch signal has been received (S11-“YES”), the circuit board 40 generates no touch control signal, at step S12.

When it is determined that the non-button touch signal is not received (S11-“NO”), the circuit board 40 determines whether the button touch signal has been received, at step S13.

When it is determined that the button touch signal is received (S13-“YES”), the circuit board 40 determines whether the first reference time Δt has elapsed, at step S14. When it is determined that the first reference time Δt has been elapsed (S14-“YES”), the circuit board 40 determines whether the non-button touch signal has been received within the first reference time Δt, at step S15.

When it is determined that the non-button touch signal is not received within the first reference time Δt (S15-“NO”), that is, when the first condition is satisfied, the circuit board 40 determines whether the second reference time Td has elapsed, at step S16. When it is determined that the second reference time Td has been elapsed (S16-“YES”), the circuit board 40 determines whether the same the button touch signal is still received, at step S17.

When it is determined that the same the button touch signal is still received (S17-“YES”), the circuit board 40 generates the touch control signal according to the received button touch signal, at step S18.

When it is determined that the same the button touch signal is no longer received (S17-“NO”), the circuit board 40 generates no touch control signal, at step S12.

Returning back to the step S15, when it is determined that the non-button touch signal has been received within the first reference time Δt (S15-“YES”), that is, when the first condition is not satisfied, the circuit board 40 generates no touch control signal, at step S12.

According to the technical solution of the present disclosure, a method for preventing mis-operation of the touch button is further provided. The touch button may include the touch film 20, and the touch film 20 may include the button detection regions 21 spaced apart from each other and the non-button detection regions 22 located around the button detection region 21, respectively.

A method for preventing mis-operation of the touch button according to the technical solution of the present disclosure may include determining whether the button detection region 21 is triggered and the non-button detection region 22 is not triggered within the first reference time Δt; determining whether the same button detection region 21 is still triggered after the second reference time Td has elapsed, when it is determined that the button detection region 21 is triggered and the non-button detection region 22 has not been triggered within the first reference time Δt; generating, by the touch button, the touch control signal corresponding to the button detection region 21 when it is determined that the same button detection region 21 is still triggered after the second reference time Td.

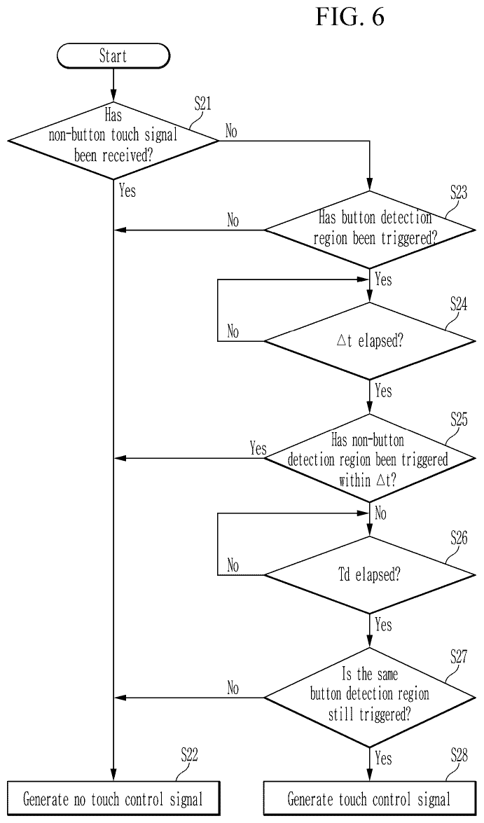

FIG. 6 is a detailed flowchart of a method for preventing mis-operation of the vehicle touch button according to the technical solution of the present disclosure. As shown in FIG. 6, a method for preventing mis-operation of the vehicle touch button according to an exemplary technical solution of the present disclosure includes the following steps:

At step S21, whether the non-button detection region 22 is triggered is determined.

When it is determined that the non-button detection region 22 has been triggered (S21-“YES”), the touch button generates no touch control signal, at step S22.

When it is determined that the non-button detection region 22 is not triggered (S21-“NO”), whether the button detection region 21 is triggered is determined, at step S23.

When it is determined that the button detection region 21 has been triggered (S23-“YES”), whether the first reference time Δt has elapsed is determined, at step S24.

When it is determined that the first reference time Δt has been elapsed (S24-“YES”), whether the non-button detection region 22 is triggered within the first reference time Δt is determined, at step S25.

When it is determined that the non-button detection region 22 has been triggered within the first reference time Δt (S25-“YES”), the touch button generates no touch control signal, at step S22.

When it is determined that the non-button detection region 22 is not triggered within the first reference time Δt (S25-“NO”), that is, it may be determined that the button detection region 21 is triggered and the non-button detection region 22 is not triggered within the first reference time Δt. At this time, whether the second reference time Td has elapsed is determined, at step S26.

When it is determined that the second reference time Td has been elapsed (S26-“YES”), whether the same button detection region 21 is still triggered is determined, at step S27. When it is determined that the same button detection region 21 is still triggered (S27-“YES”), that is, when it is determined that the same button detection region 21 is still triggered after the second reference time Td, at this time, the touch button generates the touch control signal corresponding to the button detection region 21, at step S28.

When it is determined that the same button detection region 21 is no longer triggered (S27-“NO”), the touch button generates no touch control signal, at step S22.

The vehicle touch button and a method for preventing mis-operation of the vehicle touch button according to the technical solution of the present disclosure improves the touch film 20 in the hardware aspect, where a peripheral region in the improved touch film 20 other than the respective button detection regions 21 is also set as the detection region 22 (referred to as the non-button detection region 22), so that when the user's finger touches a region other than the button touch region, the non-button detection region 22 is triggered unlike the conventional art where the detection region is not triggered, and the improvement in this hardware aspect provides a basis for preventing mis-operation of the touch button. In addition, as an improvement to a control logic in the software aspect, the improved control logic may determine whether only the button detection region 21 is triggered based on the first reference time Δt, and when it is determined that only the button detection region 21 has been triggered within the first reference time Δt, proceed a delayed detection with respect to a triggered or the non-triggered state of a previously triggered button detection region 21 based on the second reference time Td, and generate the touch control signal when the button detection region 21 is still triggered. Therefore, the performance of preventing mis-operation of the vehicle touch button may be improved.

The various embodiments of the present disclosure are not a complete list of all possible combinations, but are intended to illustrate representative aspects of the present disclosure, and the descriptions of various embodiments may be applied independently or in combination of two or more.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10: front cover
20: touch film
30: rear cover
40: circuit board

What is claimed is:

1. A vehicle touch button, comprising:
a touch film comprising:
a plurality of button detection regions spaced apart from each other; and
a plurality of non-button detection regions located around the button detection regions, respectively,
wherein the vehicle touch button is configured to:
when a button detection region of the plurality of button detection regions is triggered and a non-button detection region of the plurality of non-button detection regions is not triggered within a first reference time, generate a touch control signal corresponding to the button detection region when the button detection region is still triggered after a second reference time has elapsed.

2. The vehicle touch button of claim 1, wherein:
the vehicle touch button further comprises a touch surface,
the touch film is installed on an inner side of the touch surface,
the touch surface forms a button touch region corresponding to the plurality of button detection regions of the touch film, and forms a non-button touch region corresponding to the plurality of non-button detection regions of the touch film, and
the button touch region and the non-button touch region are configured so that the button detection region is triggered when the button touch region is touched, and the non-button detection region is triggered when the non-button touch region is touched.

3. The vehicle touch button of claim 2, wherein:
the touch film is configured to:
generate a button touch signal when the button detection region is triggered; and
generate a non-button touch signal when the non-button detection region is triggered;
the vehicle touch button further comprises a circuit board electrically connected to the touch film, and
the vehicle touch button is further configured to:
receive the button touch signal or the non-button touch signal; and
when the button touch signal is received and the non-button touch signal is not received within the first reference time, generate the touch control signal according to the received button touch signal when the same the button touch signal is still received after the second reference time.

4. The vehicle touch button of claim 3, wherein the circuit board is configured to:
determine whether the non-button touch signal has been received;
generate no touch control signal, when it is determined that the non-button touch signal has been received;
determine whether the button touch signal has been received when it is determined that the non-button touch signal has not been received;
determine whether the first reference time has elapsed when it is determined that the button touch signal has been received;
determine whether the non-button touch signal has been received within the first reference time when it is determined that the first reference time has elapsed;
generate no touch control signal when it is determined that the non-button touch signal has been received within the first reference time;
determine whether the second reference time has elapsed when it is determined that the non-button touch signal is not received within the first reference time;
determine whether the button touch signal is still received when it is determined that the second reference time has elapsed;
generate no touch control signal, when it is determined that the button touch signal is no longer received; and
generate the touch control signal according to the received button touch signal when it is determined that the button touch signal is still received.

5. The vehicle touch button of claim 1, wherein the non-button detection region comprises an interval between two adjacent button detection regions of the plurality of button detection regions.

6. The vehicle touch button of claim 3, wherein:
the vehicle touch button further comprises:
a front cover; and
a rear cover,
the front cover and the rear cover are configured to form a receiving space,
the front cover is used as the touch surface, and
the touch film and the circuit board are installed in the receiving space.

7. The vehicle touch button of claim 6, wherein, in the front cover, an icon is formed in the button touch region.

8. A method for preventing mis-operation of a touch button, wherein the touch button comprises a touch film, and the touch film comprises a plurality of button detection regions spaced apart from each other and a plurality of non-button detection regions located around the plurality of button detection regions, respectively, the method comprising:
determining whether a button detection region of the plurality of button detection regions is triggered and a non-button detection region of the plurality of non-button detection regions is not triggered within a first reference time;
determining whether the button detection region is still triggered after a second reference time has elapsed when it is determined that the button detection region is triggered and the non-button detection region is not triggered within the first reference time; and
generating, by the touch button, a touch control signal corresponding to the button detection region, when it is determined that the button detection region is still triggered after the second reference time.

9. The method of claim 8, wherein determining whether the button detection region is triggered and the non-button detection region is not triggered within the first reference time comprises:
determining whether the non-button detection region is triggered;
determining whether the button detection region is triggered when it is determined that the non-button detection region has not been triggered;
determining whether the first reference time has elapsed when it is determined that the button detection region has been triggered;
determining whether the non-button detection region is triggered within the first reference time when it is determined that the first reference time has elapsed; and
determining that the button detection region is triggered and the non-button detection region is not triggered within the first reference time when it is determined that the non-button detection region is not triggered within the first reference time.

10. The method of claim 9, wherein determining whether the button detection region is still triggered after the second reference time has elapsed comprises:
determining whether the second reference time has elapsed;
determining whether the button detection region is still triggered when it is determined that the second reference time has elapsed; and
determining that the button detection region is still triggered after the second reference time when it is determined that the button detection region is still triggered.

11. A method, comprising:
receiving, by a circuit board, a button touch signal;
making a first determination, by the circuit board, whether a non-button touch signal is received within a first reference time after receiving the button touch signal;
making a second determination, by the circuit board and when the non-button touch signal is not received within the first reference time, that the button touch signal is still received after a second reference time has elapsed; and
generating, in response to the second determination, a touch control signal,
wherein the touch control signal is received by a controller for executing an operation.

12. The method of claim 11, wherein the button touch signal is received by the circuit board from a button detection region of a touch film.

13. The method of claim 12, wherein the touch film and the circuit board are located within a receiving space formed by a front cover and a rear cover of a vehicle touch button.

14. The method of claim 13, wherein the button touch signal received by the circuit board corresponds to a touch operation, by a user, on a touch surface of the front cover of the vehicle touch button.

15. The method of claim 13, wherein the vehicle touch button is located below a display screen of a vehicle.

16. The method of claim 12, wherein:
the button detection region comprises a plurality of function detection regions, and
the button touch signal corresponds to a particular function detection region of the plurality of function detection regions.

17. The method of claim 16, wherein the button detection region further comprises a plurality of non-button detection regions located around the plurality of function detection regions.

18. The method of claim 16, wherein each of the plurality of function detection regions corresponds to an icon provided on a touch surface of a vehicle touch button comprising the touch film.

19. The method of claim 11, further comprising:
making a third determination, by the circuit board and when the non-button touch signal is received within the first reference time, not to generate the touch control signal.

20. The method of claim 11, wherein the operation comprises changing an output of a display screen of a vehicle.
